(19) United States
(12) Patent Application Publication
(10) Pub. No.: US 2005/0113996 A1
(43) Pub. Date: May 26, 2005

(54) Ambulance control system and method

(75) Inventors: Duane R. Pillar, Oshkosh, WI (US); Jeffrey J. Miller, Oshkosh, WI (US); William M. Woolman, Oshkosh, WI (US); Michael Bolton, Oshkosh, WI (US); Jacob W. Fischer, Oshkosh, WI (US); Lisa S. Breu, Oshkosh, WI (US)

Correspondence Address: FOLEY & LARDNER, 777 EAST WISCONSIN AVENUE, SUITE 3800, MILWAUKEE, WI, 53202-5308, US

(73) Assignee: Oshkosh Truck Corporation

(21) Appl. No.: 10/972,085

(22) Filed: Oct. 22, 2004

Related U.S. Application Data
(63) Continuation-in-part of application No. 10/326,862, filed on Dec. 19, 2002.
(60) Provisional application No. 60/514,277, filed on Oct. 24, 2003.
(60) Provisional application No. 60/342,292, filed on Dec. 21, 2001.

(51) Int. Cl. G06F 7/00

(52) U.S. Cl. 701/36

(57) ABSTRACT

An ambulance comprises a user interface capable of displaying input and output (“I/O”) status information and a control system coupled to the user interface. The user interface is capable of displaying video images from a video camera, map information generated based on a dispatch system, and/or other information.

### CROSS-REFERENCE TO RELATED PATENT APPLICATIONS

This application is a continuation-in-part of U.S. Ser. No. 10/326,862, filed Dec. 19, 2002, published Aug. 21, 2003 as App. No. 20030158638, which claims priority to U.S. Prov. Ser. No. 60/342,292, filed Dec. 21, 2001, each of which is hereby expressly incorporated by reference. This application also claims priority to U.S. Prov. Ser. No. 60/514,277, filed Oct. 24, 2003, also hereby incorporated by reference.

### BACKGROUND

Ambulances are widely used for transporting sick or injured individuals. Ambulances carry a variety of specialized equipment to facilitate treatment of such individuals as well as other devices commonly found on most motor vehicles. These devices may be used by the ambulance operators to care for the patient and/or to drive the ambulance. Herein, the term “operator” is used to encompass not only the driver of an ambulance, but also other personnel that may be involved with the treatment of sick or injured individuals.

The specialized equipment carried on board an ambulance may include such equipment as oxygen supplies, defibrillators, temperature control systems (e.g., heating and air conditioning systems), various specialized lighting systems, and so on. In some cases, other devices are now being placed on board ambulances that make additional information available to an operator regarding operation of the ambulance. For example, in some cases, video equipment is being placed on ambulances to monitor the patient compartment and/or to monitor the vehicle exterior (e.g., to assist maneuvering of the ambulance by providing the vehicle operator with one or more additional views of the vehicle's surroundings).

It is desirable for an operator of an ambulance to be able to monitor the equipment. For example, the operator may monitor the vehicle systems to determine whether all of the appropriate systems on the vehicle are fully operational, to determine vehicle status, and/or to determine patient status. As more devices and systems are placed on-board ambulances, improvements are desirable to make monitoring the information provided by such equipment, as well as controlling such equipment, easier for an operator of the ambulance.

Ambulances are also often left unattended at the scene of an emergency. In these situations, the vehicle is typically left with the engine running. This is done to allow certain vehicle systems to continue running and maintaining the appropriate state while the vehicle is unattended. Currently in the industry, ambulances are sometimes provided with an anti-theft feature that protects the ambulance while the ambulance is running unattended. When the vehicle operator leaves the ambulance unattended, the operator may remove the key and the ambulance will remain running. If the vehicle is shifted out of the park position, the vehicle shuts off until the vehicle operator re-inserts the ignition key. In many instances, the anti-theft feature is implemented to shut off the vehicle ignition and all the systems. Improvements in this arrangement would also be desirable.

### SUMMARY

According to a first preferred embodiment, an ambulance comprises a video camera, a plurality of input devices and a plurality of output devices, a plurality of microprocessor-based interface modules, a communication network, and an user interface including a display. The plurality of interface modules are interconnected to each other by way of the communication network. Each of the plurality of interface modules is coupled to respective ones of the plurality of input devices and the plurality of output devices to control operation of the plurality of output devices based on input status information from the plurality of inputs devices. The display is configured to display I/O status information regarding the plurality of input devices and the plurality of output devices, and is configured to display video images provided by the video camera.

According to a second preferred embodiment, a control system for an ambulance comprises a power source, a power transmission link, a plurality of input devices, a plurality of output devices, a plurality of microprocessor-based interface modules, and a communication network. The plurality of interface modules are coupled to the power source by way of the power transmission link and are interconnected to each other by way of the communication network. Each of the plurality of interface modules being coupled to respective ones of the plurality of input devices and the plurality of output devices. The control system is configured to disable operation of the ambulance until proper vehicle authorization is provided. The control system is configured to allow engine of the ambulance to remain running without an ignition key being inserted, and to disable the ambulance when an operator input is received without the ignition key being reinserted.

### BRIEF DESCRIPTION OF THE DRAWINGS

The invention will be more readily understood by reference to the following description taken with the accompanying drawings, in which:

FIG. 1 is a block diagram of an exemplary control system for an ambulance.

FIG. 2 is a block diagram of devices coupled to provide information to a user interface in the ambulance of FIG. 1.

FIG. 3 is a display screen of a user interface, providing vehicle status information to the vehicle operator and providing a main menu.

FIG. 4 is a display screen of the user interface of FIG. 1 showing GPS coordinates of an ambulance.

FIG. 5A is a display screen of the user interface of FIG. 1 relating to a menu listing of control system modules; and FIGS. 5B and 5C are display screens of the user interface of FIG. 3 which display a sub-menu of the module listing, particularly depicting the status of various input/output devices.

FIGS. 6A and 6B are display screens of a user interface of FIG. 1 relating to load manager configuration.

FIG. 7 is a display screen of the user interface of FIG. 1 showing climate control status.

FIGS. 8A and 8B are display screens of a user interface of FIG. 1 relating to strobe flasher configuration.

FIG. 9 is a block diagram of devices coupled to provide information to a user interface in the ambulance of FIG. 1 in another exemplary embodiment.

FIGS. 10-11 are display screens of the user interface of FIG. 1, providing vehicle status and other information to the vehicle operator and providing a main menu.

FIG. 12 is a flowchart showing a theft-protection method which may be implemented by the control system of FIG. 1.

FIG. 13 is a flowchart showing a lighting control method which may be implemented by the control system of FIG. 1.

### DETAILED DESCRIPTION OF EXEMPLARY EMBODIMENTS

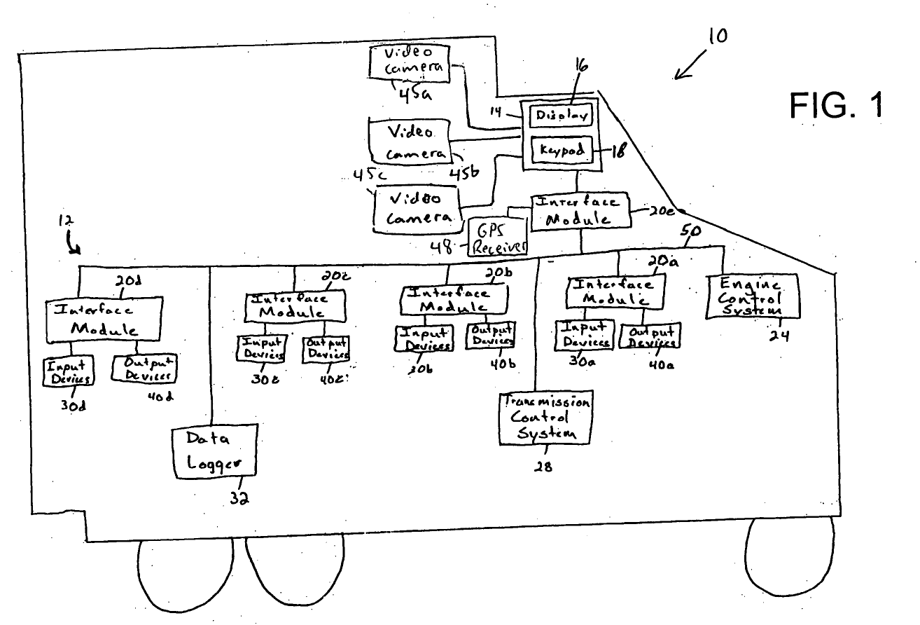

Referring to FIG. 1, an exemplary embodiment of an ambulance 10, having an electronic control system 12, is illustrated. By way of overview, the electronic control system 12 includes a user interface 14, a plurality of microprocessor-based interface modules 20a-20e (collectively referred to as interface modules 20), a plurality of input devices 30a-30d (collectively referred to as input devices 30), a plurality of output devices 40a-40d (collectively referred to as output device 40), a data logger 32, and a plurality of additional vehicle control systems 24 and 28. The user interface 14 and interface modules 20 are coupled to each other by a communication network 50.

Control system 12 may be configured in a number of different ways. For example, control system 12 may be configured to include multiple control systems that are coupled together. Also, control system 12 may be configured to include multiple nested control systems so that control system 12 includes one or more sub-control systems that form parts of the overall control system 12. Thus, it should be understood that the particular configuration of control system 12 shown in FIG. 1 is only one of many possible embodiments.

Control system 12 can be configured to monitor a number of systems used to provide emergency medical care within the ambulance 10. Examples of these systems may include the oxygen delivery system, the climate control system, power to a defibrillator, etc. The I/O devices 30 and 40 may include I/O devices associated with these systems (e.g., a pressure sensor to measure oxygen level, switches such as relays to control operation of the heating/air conditioning system, switches to control power to a defibrillator, temperature sensors to measure indoor and outdoor temperatures, one or more input devices for an operator to provide information regarding patient status (green, yellow, red) to the system 12, and so on). Control system 12 may be used to control these systems from the user interface 14. The advantages of control system 12, which are described using the example of the ambulance, may equally apply to other types of vehicles.

In an exemplary embodiment, interface modules 20 are microprocessor-based and are connected to and communicate with input and output devices 30 and 40. In general, in order to minimize wiring, the interface modules 20 are placed close to input devices 30, from which status information is received, and output devices 40 that are controlled. In one embodiment, interface modules 20 are coupled to input devices 30 and output devices 40 via dedicated communication links, which may simply be a hardwired link between an interface module 20 and an input device 30 or an output device 40. In an alternative embodiment, an input device 30 or an output device 40 may be coupled directly to communication network 50 and configured to communicate directly over communication network 50 to all of the interface modules (e.g., the status of the device is broadcast over the network), one interface module (e.g., the interface module requested information from the particular input device 30 or output device 40), or a subset of interface modules on the network.

In an exemplary embodiment, interface modules 20 are identical both in software, hardware, and physical dimensions. Thus, interface modules 20 are physically and functionally interchangeable because they are capable of being plugged in at any slot on communication network 50, and are capable of performing any functions that are required at that slot. In an alternative embodiment, interface modules 20 may be different in software, hardware, and/or physical dimensions, for example being optimized into a limited number of different configurations (e.g., with different interface modules being configured to connect to different types of I/O devices).

In an exemplary embodiment, each of the interface modules 20 stores I/O status information for all of the other interface modules 20. In this configuration, each interface module has total system awareness. As a result, each interface module 20 processes its own inputs and outputs based on the I/O status information. The I/O status information may be provided to interface modules 20 in a number of ways. For example, in an exemplary embodiment, each of interface modules 20 may be configured to broadcast the status of input devices 30 over communication network 50 to the other interface modules 20 at predetermined intervals. In another exemplary embodiment, interface modules 20 may be configured to simultaneously or sequentially broadcast the status information to the other interface modules 20. In another exemplary embodiment, interface modules 20 may be configured to broadcast the status information in response to a change in the state of an input device 30. This lessens the amount of traffic over communication network 50. In another exemplary embodiment, interface modules 20 may be configured to regularly transmit status information to a central controller which executes a control program to control operations of the interface modules 20.

In another exemplary embodiment, as mentioned previously, some of the input and/or output devices 30 or 40 may be coupled directly to communication network 50. In this configuration, the input devices 30 can broadcast status information across network 50 to interface modules 20. Input and/or output devices 30 or 40 coupled directly to communication network 50 typically do not store the status information broadcast across the network for other I/O devices. Thus, one or more of interface modules 20 may be configured to control input and/or output devices 30 or 40 coupled directly to communication network 50. However, in an alternative embodiment, input and/or output devices 30 or 40 may be configured to store the status information broadcast by the other interface modules 20 and/or other devices on communication network 50.

Communication network 50 may be implemented using an appropriate network protocol. In an exemplary embodiment, communication network 50 uses a network protocol that is in compliance with the Society of Automotive Engineers (SAE) J1708/1587 and/or J1939 standards. However, the particular network protocol that is utilized is not critical.

The transmission medium for communication network 50 may be implemented using copper or fiber optic cable or other media. Communication network 50 may be configured in a number of ways. For example, in an exemplary embodiment, network 50 may be a single network. In another exemplary embodiment, network 50 may be comprised of multiple networks coupled together.

Power is provided to interface modules 20 from a power source by way of a power transmission link. The power transmission link may comprise, for example, a power line that is routed throughout ambulance 10 to each of interface modules 20. Interface modules 20 then distribute the power to output devices 40. This type of distributed power transmission reduces the amount of wiring needed for ambulance 10.

Input devices 30 and output devices 40 are generally located on the chassis of ambulance 10. In an exemplary embodiment, input devices 30 include devices that provide inputs used to control output devices 40. Also, input devices 30 may include devices that provide status information pertaining to vehicle parameters that are not used to control output devices 40 but may be used for other purposes (e.g., diagnosing faults in ambulance 10, generating reports regarding utilization of ambulance 10, inform operator of status of a device, etc.).

The various blocks depicting interface modules 20, input devices 30, output devices 40, user interface 14, etc., may be implemented as physically separate units, physically integrated units, or a combination of both. For example, interface module 20 and user interface 14 may be physically combined in one housing that performs the same function of both interface module 20 and user interface 14. In another embodiment, a particular input device 30 or output device 40 may be integrated physically with an interface module 20 so that the resulting combination functions in a manner that is similar to a configuration where the devices are separate yet still coupled together.

The user interface 14 shown in FIG. 1 includes a display 16 and a keypad 18. However, user interface 14 may include any of a number of components that are used by the operator to interface with control system 12. In general, user interface 14 includes one or more devices that are used to communicate information to the operator (e.g., display 16, LEDs, etc.) and one or more devices that the operator uses to communicate information to control system 12 (e.g., keypad 18, joystick, buttons, switches, etc.). The keypad 18 may be provided separately (e.g., one or more buttons located alongside the display 16, a separate keyboard, etc) or integrally with the display 16 (e.g., a touchscreen display). User interface 14 allows the operator to easily determine the status of input and output devices 30 and 40 as well as other control systems and devices that are coupled to communication network 50. As described below, the vehicle operator is also able to use user interface 14 to view video images of the patient compartment and/or of the vehicle exterior. In an exemplary embodiment, user interface 14 includes a microprocessor and memory so the user interface may be programmed by the operator and may interact intelligently with the remainder of the control system 12.

Display 16 is used to communicate, and in particular to display, information to the operator. Display 16 may be one of a number of various types of displays such as an LCD display, alpha-numeric display, touch screen display, SVGA display and so on. In one embodiment, as described in greater detail, the display 16 is used to display information from the control system 12. The display 16 may also comprise a heads-up display to allow information to be projected in front of a driver of the ambulance 10 (e.g., in a view space which allows the driver's eyes to focus at a location in traffic or otherwise well in front of the vehicle) so that the driver may view the information in the display while also driving the ambulance 10. The display 16 may also comprise a display which is mounted on the steering wheel or column of the ambulance 10. In another embodiment, also as described in greater detail, the display 16 is used to display information from the control system 12 as well as video information from one or more video cameras 45a and 45b mounted on the ambulance.

In an exemplary embodiment, user interface 14 is semi-permanently mounted within ambulance 10. By semi-permanently mounted, it is meant that the user interface 14 is mounted within the ambulance 10 in a manner that is sufficiently rugged to withstand normal operation of the vehicle for extended periods of time (at least days or weeks) and still remain operational, while still allowing the user interface 14 to be removed (e.g., for servicing of the intelligent display module) without significantly degrading the structural integrity of the mounting structure employed to mount user interface 14 to the remainder of ambulance 10. In one embodiment, the user interface 14 may remain in communication with the control system 12 even after it is removed from the operator compartment (e.g., via a blue tooth link), to allow an operator to manipulate I/O states while moving around and about the ambulance 10 (e.g., to diagnose malfunctions). User interface 14 is desirably mounted in an operator compartment of ambulance 10, for example, in a recessed compartment within the operator compartment or on an operator panel provided on the dashboard. Also, while FIG. 1 shows one user interface 14, it should be understood that additional interfaces may also be used.

Additional control systems 24 and 28 may also be included as part of control system 12. In an exemplary embodiment depicted in FIG. 1, an engine control system 24 and a transmission control system 28 are included as part of control system 12. In an alternative embodiment, control system 12 may include various additional control systems in a number of configurations. The control systems 24 and 28 may be coupled directly to the communication network 50 of control system 12, as shown in FIG. 1. Alternatively, control systems 24 and 28 may be coupled to one or more interface modules 20, which are coupled to communication network 50. In practice, some or all of the control systems 24 and 28 are likely to be purchased as off-the-shelf systems. If control systems 24 and 28 are coupled to communication network 50 using one or more interface modules 20, then interface modules 20 may be used to facilitate communication between network 50 and control systems 24 and 28.

By connecting control systems 24 and 28 to control system 12, an array of additional input and output status information becomes available. For example, for the engine, this allows the control system 12 to obtain I/O status information pertaining to engine speed, engine hours, oil level, coolant level, fuel level, and so on. For the transmission, this allows control system 12 to obtain, for example, information pertaining to transmission temperature, transmission fluid level and/or transmission state (e.g., 1^{st} gear, 2^{nd} gear, and so on). Assuming that an off-the-shelf engine or transmission control system is used, the information that is available depends on the manufacturer of the system and the information that they have chosen to make available.

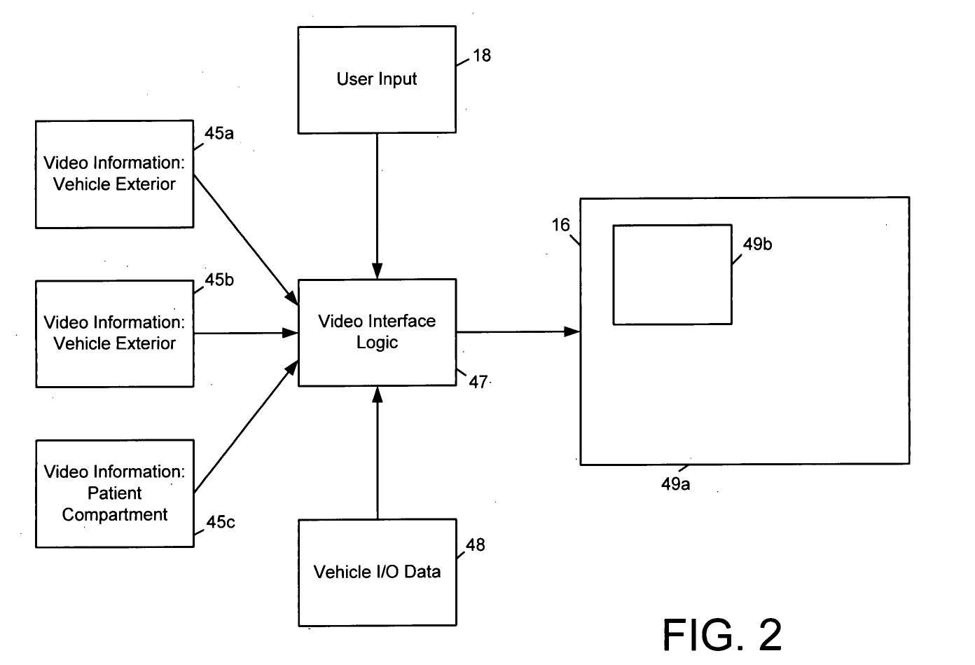

Referring now to FIG. 2, operation of the system 12 to provide information to the operator by way of the display 16 is now described in greater detail. Display 16 may be capable of displaying I/O status information from the control system 12. Display 16 may also be capable of displaying visual images of the exterior of the ambulance 10 (using video cameras 45a and 45b) and of the patient compartment (using video information provided by video camera 45c). This provides the operator with an exterior view of ambulance 10, assisting the vehicle operator in maneuvering the vehicle. This also provides the vehicle operator with visual images of the patient compartment, allowing the operator to quickly assess what is happening in the patient compartment and/or informing the vehicle operator of the patient's health status. The control system 12 allows the vehicle operator to simultaneously monitor the status of the vehicle systems and view the visual images on display 16 of user interface 14. The video information from one or more of the video cameras 45a-45c may also be provided to a video recording device to create a record of the operation of the vehicle and/or the events in the patient compartment during the patient's trip to a health care facility.

In one embodiment, the video cameras 45a and 45b are mounted on the ambulance 10 so as to obtain video information in different directions away from the ambulance. For example, one or more of the cameras 45a and 45b may be positioned to view a region in back of the ambulance 10. Video interface logic 47 may then be configured to alter a manner in which the video information from the video cameras 45a and 45b is displayed depending on a direction of movement of the ambulance. In practice, the video interface logic may be configured as part of the display 16 or as separate logic. In one embodiment, the display 16 includes multiple video inputs and is capable of selecting between the video inputs (e.g., to provide a picture-in-picture display). The selection may occur using either internal or external interface logic 47. If external logic is employed, a selector signal may be provided to the display 16 indicating which mode of operation has been selected.

For example, if the video interface logic 47 determines that the ambulance 10 is moving backward (e.g., if the transmission has been put into reverse), the video interface logic may automatically switch to the video information provided by the camera that is mounted at the back of the ambulance 10. Alternatively, the cameras 45a and 45b may be mounted on the side of the ambulance 10, and the video interface logic 47 may switch between the cameras 45a and 45b depending on a direction the vehicle is turning (as indicated, e.g., by an input from the steering wheel or other steering sensor). As yet another alternative, the video interface logic 47 may display video information from the video cameras 45a and 45b as a function of speed. For example, if the ambulance reaches a certain forward speed, then the video interface logic 47 may be configured to deactivate the video feed from the video cameras 45a and 45b (on the assumption that the operator will drive the ambulance normally).

The display 16 may display information from the cameras 45a-45c in a variety of formats. In one configuration, shown in FIG. 2, a picture-in-picture configuration is used. For example, video information from one of the cameras 45a-45c may be displayed in a display region 49, and I/O status information from the control system 12 (represented by block 48) may be simultaneously displayed in a display region 49b. Any combination of display of information from the various sources (video cameras 45a-45c, I/O status information from the control system 12) is possible in connection with the display regions 49a and 49b. In another embodiment, the display 16 only displays information from one source at a time. Other configurations (e.g., side by side) may also be used. The video interface logic may also operate responsive to user inputs, e.g., from keypad 18. This permits the operator to toggle back and forth between display information from different sources on the display 16 based on user inputs.

Although the display arrangement of FIG. 2 is discussed in the context of an ambulance, it will be appreciated that this feature as well (as other features described herein) may also be implemented in the context of the other vehicles described in App. No. 20030158638, including fire trucks, airport rescue and fire fighting (ARFF) vehicles, military vehicles, non-military vehicles, refuse handling vehicles, concrete transport/placement vehicles, etc.

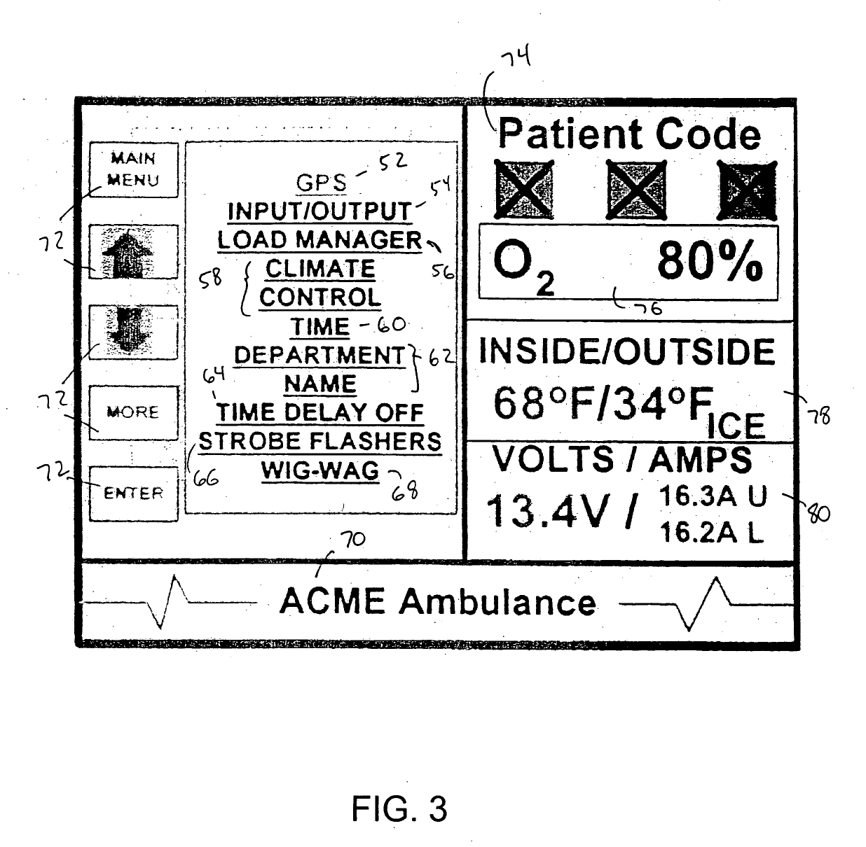

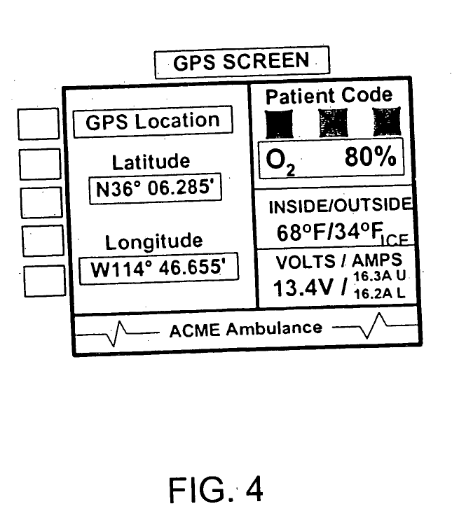

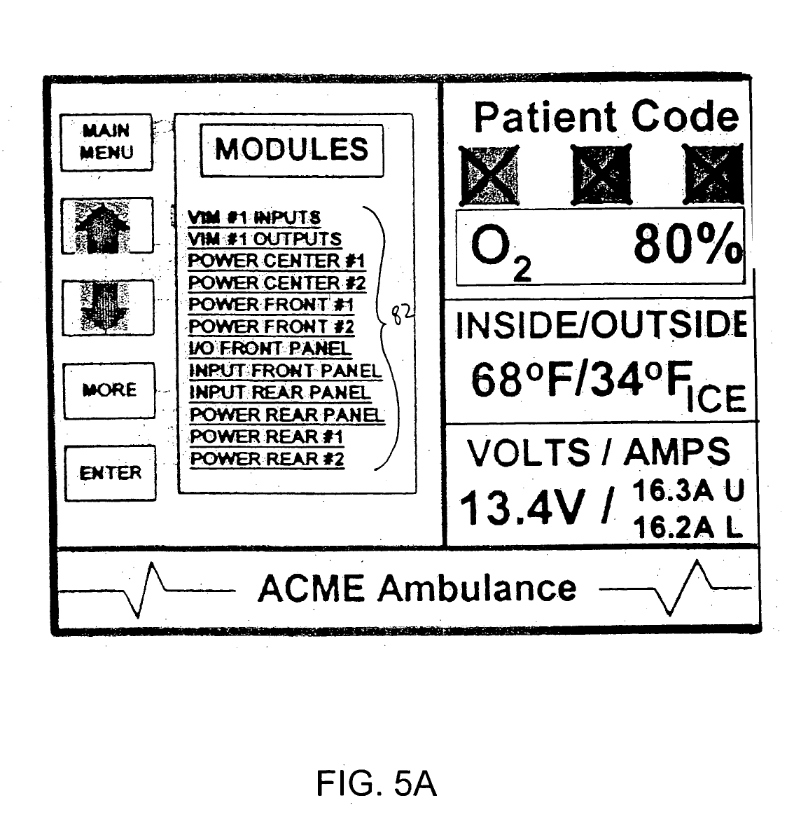

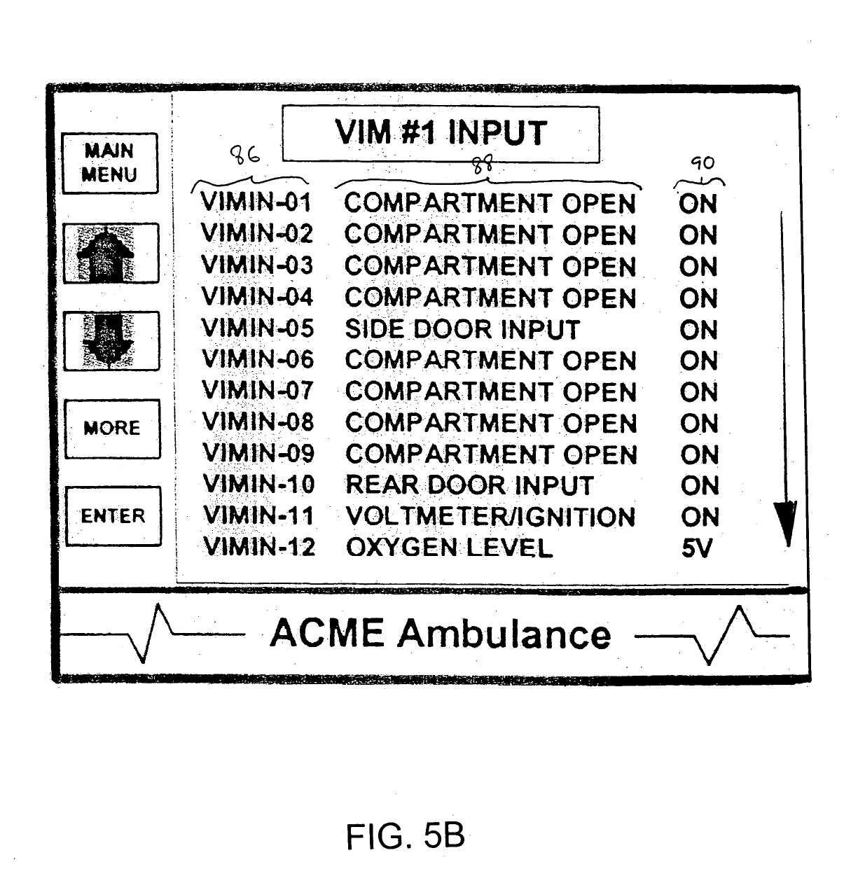

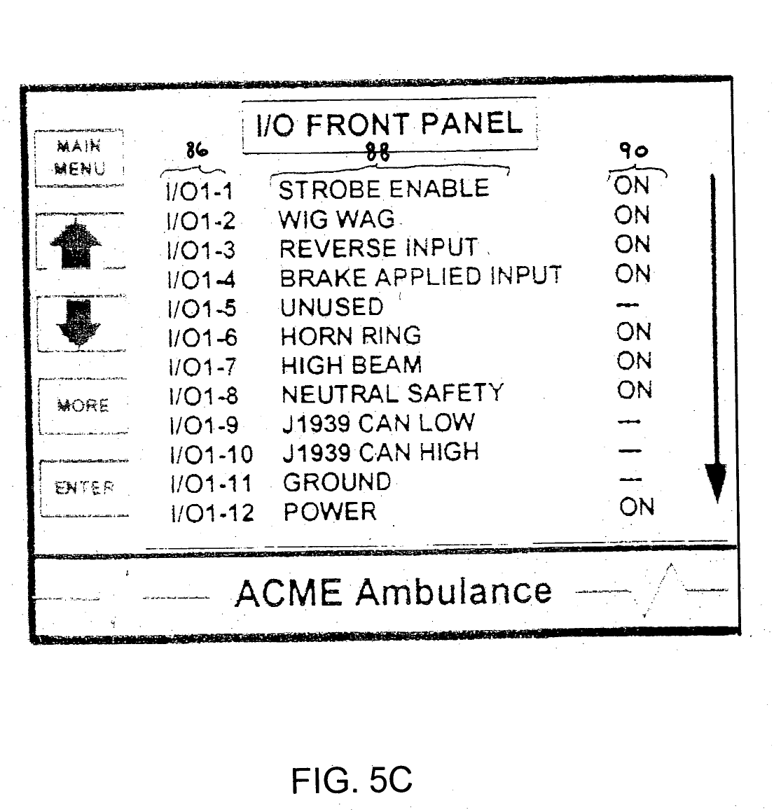

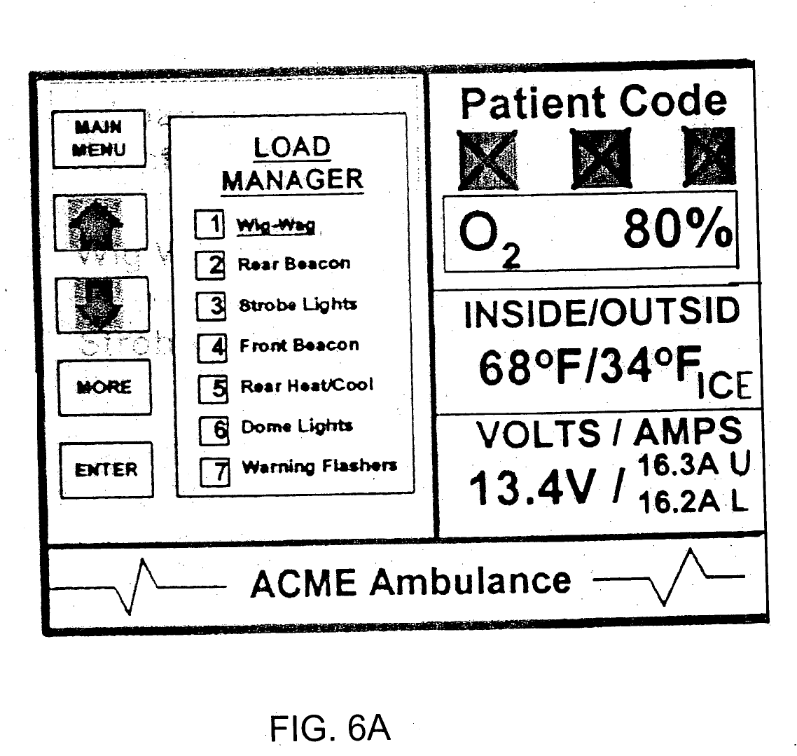

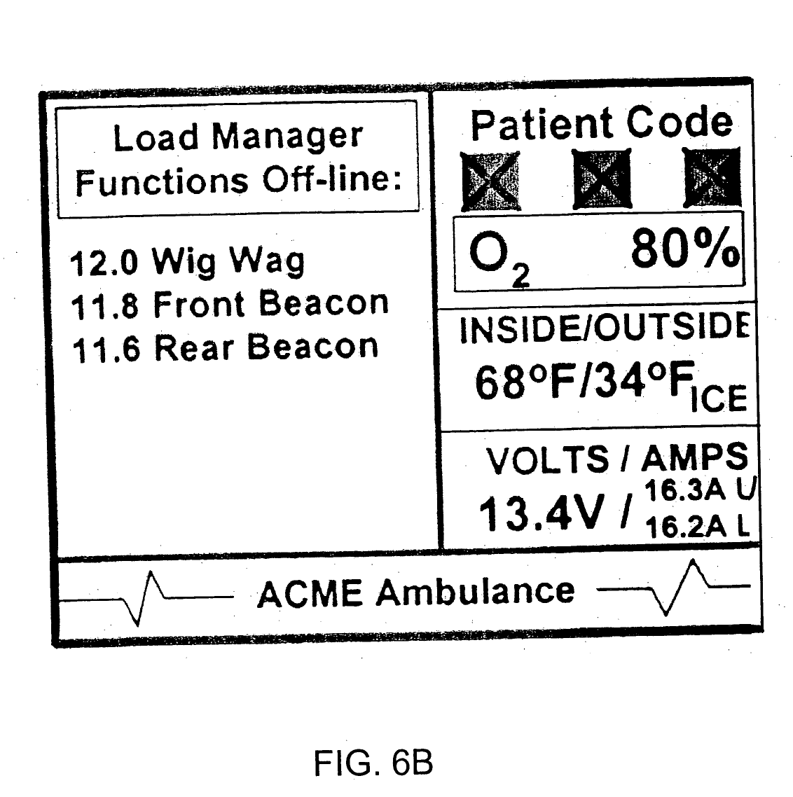

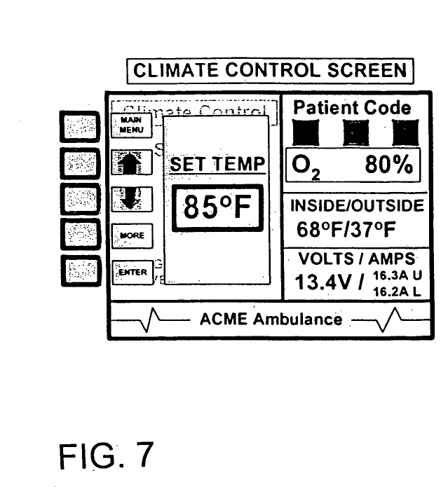

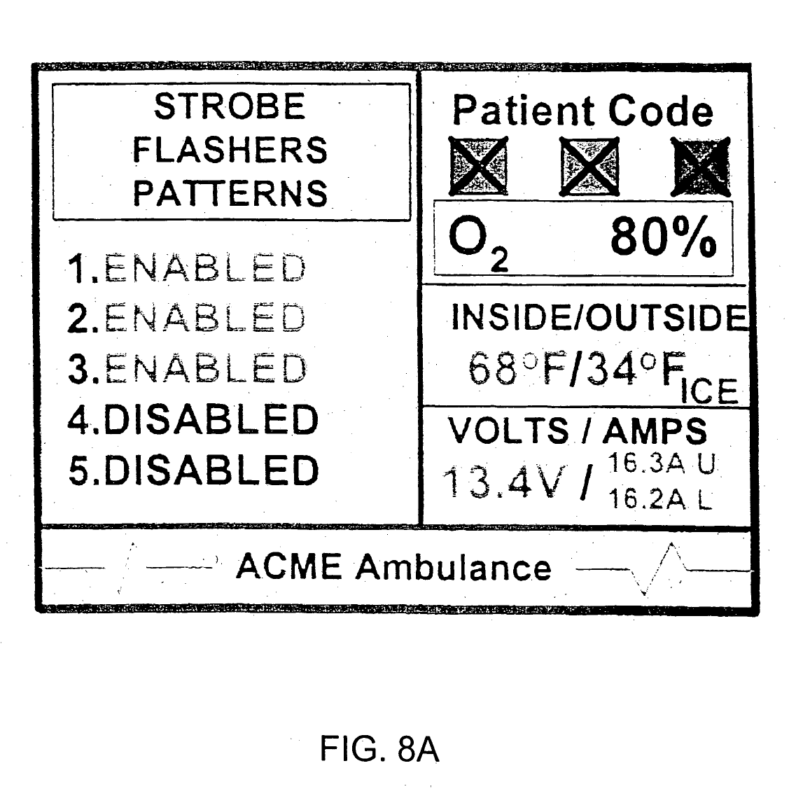

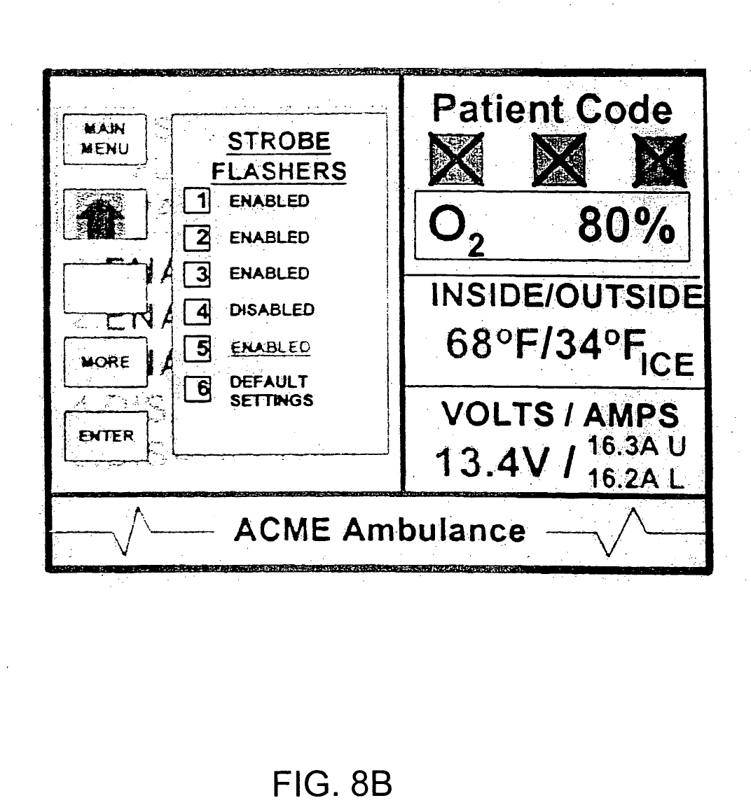

FIGS. 3-8B show various screens that may form the I/O status information provided by block 48 in FIG. 2 to the display 16. FIG. 3 is a screen display provided by display 16 showing vehicle status information to the vehicle operator, particularly a main menu of the user interface 14. The main menu screen on display 16 provides a listing of the vehicle systems and settings able to be controlled and/or monitored by the vehicle operator through the user interface 14. The vehicle operator may drill down through various menus to monitor and manipulate the vehicle status information as necessary. As shown in FIG. 3, the main menu screen on display 16 provides a GPS option 52 to view vehicle GPS coordinates as provided by GPS receiver 53 (see FIG. 1), an input/output option 54 to drill down on I/O states of the input devices 30 and the output devices 40 connected to the interface modules 20 (see FIGS. 5A-5C, described below), a load manager option 56 to adjust an order in which output devices 40 start turning off to conserve batter power when battery power is running low (see FIGS. 6A-6B, described below), a climate control option 58 to adjust climate control settings for the ambulance 10 (see FIG. 7), a time option 60 to display current time, a department name option 62 to adjust a department name 70 displayed by the display 16, a time delay option 64 to adjust an adjustable time delay off of dome lights of the ambulance 10, a strobe flashers option 66 to adjust operation of strobe flasher emergency lighting (see FIGS. 8A-8B, described below), and a wig wag option 68 to adjust operation of wig wag emergency lighting. Buttons 72 permit the operator to navigate the menu and make menu selections. Buttons 72 may be actual input devices (e.g., where the keypad 18 is implemented in the form of a touch screen) or may simply correspond to input devices (e.g., where the keypad 18 is implemented in the form of keys lined up alongside the display 16 next to the buttons 72). Other configurations (e.g., a mouse or other input device for selecting menu options) may also be used.

Also shown in FIG. 3 is a patient indicator 74 comprising green, yellow and red lights. The indicator 74 provides the driver with the vehicle with the status of the patient and may be responsive, for example, to an input device (e.g., a multi-position switch) operated by another operator in a patient compartment of the ambulance 10. An oxygen level indicator 76 indicates an amount of oxygen available in a oxygen supply available for patient use. A temperature indicator 78 indicates inside and outside temperatures. A voltage indicator indicates a battery voltage of the ambulance 10.

FIG. 5A is a display screen of the user interface 14 allowing an operator to drill down on I/O states of the input devices 30 and the output devices 40 connected to the interface modules 20. Each option 82 allows a different interface module 20 to be selected. The operator may then drill down on a particular interface module to display the I/O states of the input devices 30 and the output devices 40 to which it is connected. Thus, the I/O screen allows the vehicle operator to select a module from the menu for I/O mapping, and the vehicle operator can navigate to sub-menus for each I/O module. FIGS. 5B-5C show examples of this arrangement, particularly displaying an I/O device/point field 86, an I/O device label field 88, and an I/O status indicator field 90 showing the status of a particular I/O device associated with one of the input devices 30 or output devices 40 connected to the selected interface module 20. Each module listed in FIG. 5A has a corresponding sub-menu similar to those exhibited in FIG. 5B-5C.

To facilitate diagnosing malfunctions in the control system 12 or other vehicle devices, the operator may also be provided with the ability to manipulate I/O states of the control system 12 by way of the user interface 14, e.g., to allow an operator to manually override an input device (e.g., a switch) and monitor resulting behavior of a corresponding output device to help pinpoint the source of a malfunction. User interface 14 may be configured to provide instructions to the operator for performing various operations such as diagnostics, calibrating vehicle parameters, etc. For example, display 16 may be used to prompt the operator to enter information using keypad 18, buttons or other input device. Generally speaking, any of the diagnostic and other functions described in App. No. 20030158638 may be incorporated.

With reference to FIGS. 6A-6B, FIG. 6A is a display screen of the user interface 14 for adjusting a load management system. The user interface 14 may be used by the vehicle operator to manipulate the order in which loads are deactivated. The screen lists an exemplary sequence in which seven load systems (each potentially comprising a number of output devices) will sequentially be deactivated as the vehicle battery voltage drops below predefined levels. The load management system begins to deactivate certain predefined loads as the battery voltage decreases beyond a specified level, e.g., in 0.2 volt increments. FIG. 6B is a display screen of the user interface 14, where the vehicle operator may examine which systems have been deactivated as a result of the decrease in vehicle battery voltage, along with the voltage at which the system is set to deactivate. In another embodiment, the user interface 14 may be used by the operator to further configure and customize operation of the load management system (e.g., to group individual output devices into subsystems, to define labels for the subsystems, to program the order in which the individual user-defined subsystems deactivate, and so on).

With reference to FIGS. 8A-8B, control system 12 may be configured to enable and disable different flash patterns for ambulance 10. In an emergency situation, the vehicle operator may desire to activate certain flasher patterns without proceeding through the entire preset sequence of flash patterns. For example, in many instances the vehicle operator may desire to alter the preset flash patterns of the vehicle depending on the urgency of the situation. Another possible configuration is to provide multiple onboard color displays in the patient compartment of the ambulance 10. In addition to using the user interface 14, the vehicle operator may also use onboard displays in the patient compartment to program and select different flash patterns for ambulance 10.

FIG. 8A is a display screen of the user interface 14 which indicates which strobe flasher patterns are enabled and which are disabled. If an operator desires to alter which strobe flasher patterns are enabled, the operator may push one or more predefined buttons to advance to a screen display as shown in FIG. 8B. FIG. 8B is the display 16 screen of the user interface 14, where the vehicle operator may manipulate which flasher patterns are enabled and disabled. The operator may scroll to a particular pattern (options 1-5) and toggle its setting, or scroll to menu option 6 to return to default settings. The same arrangement may be used for the wig-wag lighting.

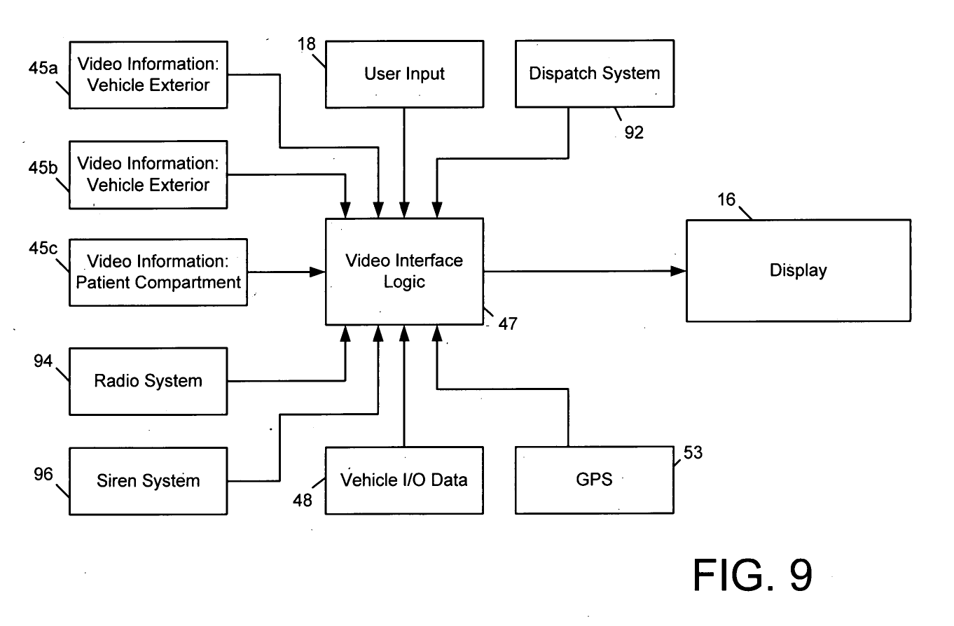

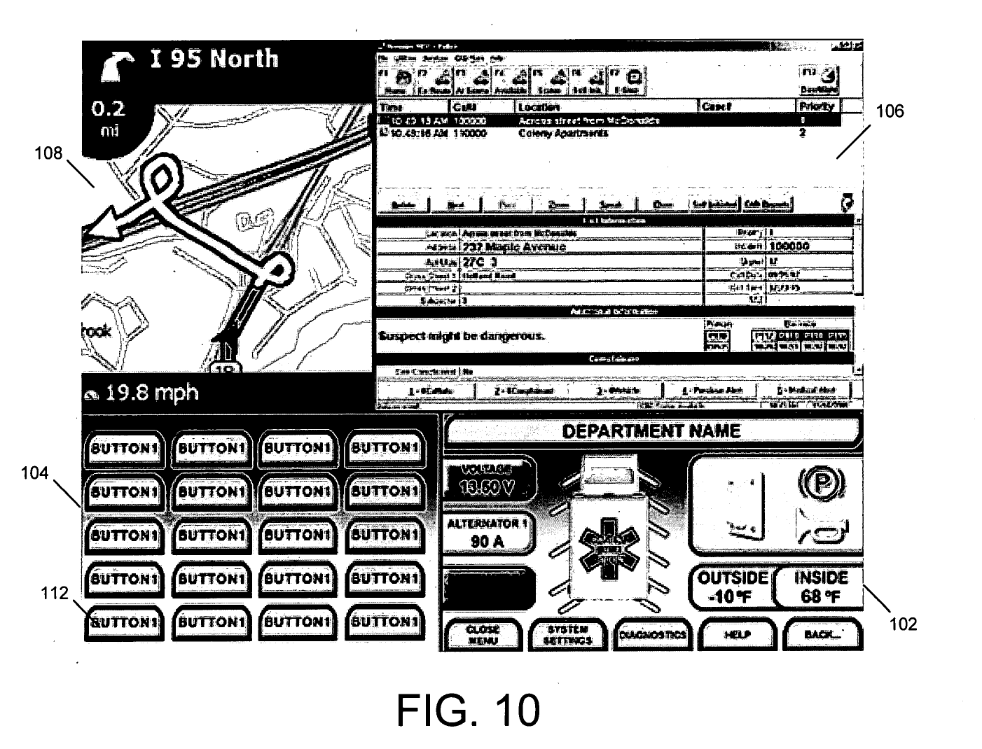

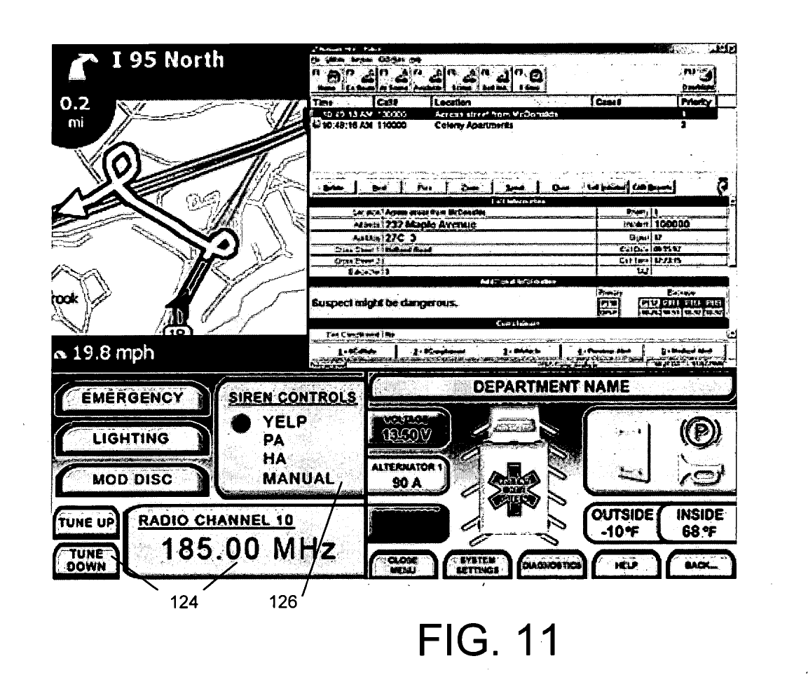

Referring now to FIGS. 9-11, the user interface 14 may be configured to display information from a variety of other sources of information. FIG. 9 is a block diagram which is similar to FIG. 2, except that additional sources of information are shown. FIGS. 10-11 are display screens which are similar to the display screen of FIG. 3, except that it displays information from one or more of the sources shown in FIG. 9.

As shown in FIG. 9, additional sources of information may be connected to the video interface logic 47. The additional sources of information may, for example, include a dispatch system 92, a radio system 94, and a siren system 96. It will be appreciated that information may be received by the user interface 14 directly from the systems 92-96 or indirectly by way of one of the interface modules 20. In an exemplary embodiment, the user interface 14 of FIGS. 9-11 is implemented using a ruggedized personal computer. In this embodiment, the display 16 and the keypad 18 are integrally provided (i.e., a touchscreen display) and are mounted in an operator compartment of ambulance 10, for example, in a recessed compartment within the operator compartment or on an operator panel provided on the dashboard, with other hardware including a central processing unit being mounted elsewhere (e.g., under a seat console). The display 16 may, for example, be a color display having a 800×600 pixel resolution, a 1024×768 pixel resolution, or greater. The video interface logic 47 may be implemented by program memory and microprocessor of the personal computer and may include program logic to combine information from the systems 45a-45c, 48, 53, and 92-98 and provide an output signal to display 16.

As shown in FIG. 10, display 16 may display information from the systems 45a-45c, 48, 53, and 92-96 in a variety of different display regions 102, 104, 106, and 108. In a region 102, a user interface is provided for vehicle information and diagnostics. Region 102 is another embodiment of a main menu screen, analogous to that shown in FIG. 3. As will be appreciated, a user may be permitted to navigate the menu and make menu selections, either by adding additional screens or by using the display screens described above in connection with FIGS. 3-8B.

In region 104, a button panel is provided which may be used by the operator to provide inputs to adjust operation of the control system 12. Buttons or other switches 112 are provided on the touchscreen which can be “pressed” by an operator to control operation of output devices connected to the interface modules 20. The buttons 112 may activate vehicle functions such as module lighting, security system, siren modes, etc. The operator may be provided with the ability to navigate between different menus or groups of buttons 112 corresponding to different vehicle functions, and make different menu selections (e.g., to control different output devices) based on which group of buttons is displayed. Although a generic “Button 1” label is depicted, it will be appreciated that different buttons 112 may be displayed with different labels that provide descriptions of the output device 40 (or other vehicle function) controlled by the respective button 112.

In region 106, information provided by dispatch system 92 is displayed. Dispatch system 92 may be used to provide an operator of ambulance 10 with information concerning a dispatch location to which the ambulance has been dispatched (e.g., address information), along with priority information and other information. The dispatch system 92 may also be used to track status, log times and dispatch-related events, and so on. The dispatch system 92 may also provide for data exchange with billing or tripsheet software.

In a region 108, map information is displayed. The map information may be generated based on pre-stored maps, information regarding a present location from GPS system 53, and information regarding a desired location from the dispatch system 92. The map information may show a preferred route from the present location to the desired location, as shown.

Other regions may also be displayed. For example, as shown in FIG. 11, a display region 124 for the radio system 94 may be provided. The display region 124 may be used to control frequency and volume of the radio system 94. Likewise, a display region 126 for a siren amplifier and head unit may be provided to allow siren modes and activation to be controlled. Also, in addition to the input device 18, a speech recognition system may be provided to allow voice control of some or all functions and thereby to allow hand-free operation of the vehicle. The speech recognition software may execute on the user interface 14 (e.g., a ruggedized personal computer) and one or more microphones may be mounted in the ambulance 10. For example, a microphone may be integrally provided with the display 16. Alternatively, the microphone may be connected to one of the interface modules 20, and information from the microphone may be transmitted via communication network 50. If desired, the display shown in FIG. 9 may be combined with video information from cameras 45a-45c in a picture-in-picture arrangement as described above in connection with FIG. 2.

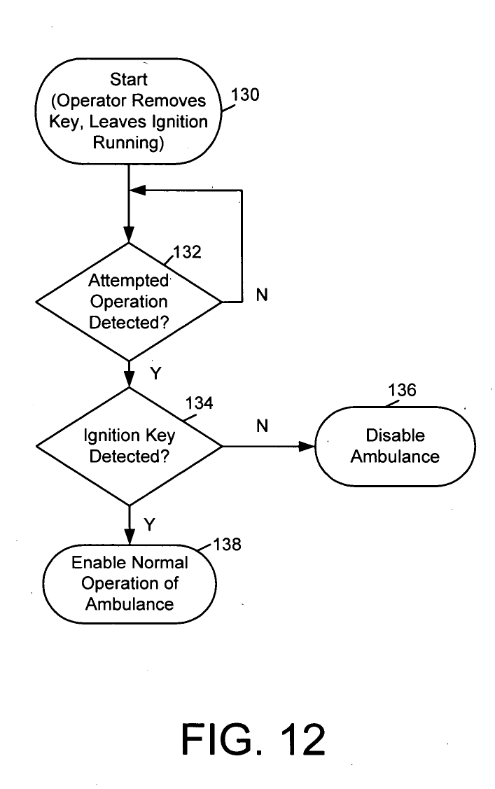

With reference to FIG. 12, in exemplary embodiment, control system 12 may be configured to implement anti-theft protection. In this embodiment, control system 12 is configured to activate transmission control system 28 in disabling ambulance 10 from traveling if the transmission is shifted from the park position without the ignition key being inserted. FIG. 12 is a flowchart showing a method for disabling the ambulance. For example, control system 12 may be configured such that the operator is permitted to remove an ignition key from ambulance 10 yet leave the ambulance running. If another (unauthorized operator) attempts to use ambulance without inserting the ignition key, then the ignition shuts off and ambulance 10 stops running. This allows patient care systems (e.g., climate control) to remain running even though the operator has left the ambulance to attend to a patient.

FIG. 12 provides a sequence of events that occurs when the disabling feature of control system 12 is activated. At step 130, the process is initiated when an operator removes the ignition key from the ambulance but leaves the ignition running. Thus, the critical systems of ambulance 10 (e.g., oxygen delivery system, power to a defibrillator, climate control system, etc.) are not shut down when the operator leaves the ambulance. The ambulance 10 then remains in this state until it is detected (at step 132) that an operator is attempting to operate the ambulance 10. This may be detected based on detection that a foot pedal has been depressed, or based on detection that the operator is attempting to change gear of the ambulance (e.g., into drive). When this occurs, the change in state of an input device associated with the pedal or the transmission shifter is detected by an interface module 20. At this time, it is also ascertained whether the ignition key has been returned to an ignition key receiving device (step 134). Again, this may be performed by one of the interface modules 20 to which the ignition key receiving device is connected. If no key is present, then the ambulance is disabled (step 136). For example, one of the interface modules 20 may send an appropriate signal to the engine control unit 24 to cause the engine control unit 24 to shut off the engine. This prevents unauthorized operation of the ambulance 10, e.g., by an unauthorized operator attempting to steal the ambulance. On the other hand, if the ignition key is detected, then the control system 12 allows normal operation of the ambulance to resume (step 138).

An advantage of implementing the theft-protection function through the control system 12 is that it allows operation of the theft protection function to be configured according to operator preferences. For example, the operator may be allowed to define a group of output devices 40 by way of the user interface 14 which are allowed to remain running when the ignition key is removed. Thus, a suitable sequence of screens as in FIGS. 5A-5C may be provided to allow an operator to drill down, select output devices 40, and define a group of output devices 40 to remain operational during steps 104-106. Different preset configurations may also be defined, e.g., to allow different configurations to be used depending on what equipment it is anticipated will be need to treat a particular patient. Additionally, the operator may also be provided with the ability to configure the operation of the theft-protection function in the event the operation of the ambulance is disabled. For example, it may be desirable to leave the ambulance running and instead activate certain sirens or lights to draw attention to the ambulance 10 at step 108.

Additionally, assuming the user interface 14 is provided as a removable interface that is wirelessly connected to the ambulance 10, the operation of the ambulance 10 may be controlled remotely. The user interface 14 may transmit wireless signals to the remainder of the control system 12 at the ambulance 10 to control operation of the ambulance 10. For example, if it is taking longer than expected to perform initial on-site treatment of a patient before loading a patient into the ambulance, the user interface 14 may be used by the operator to cause the ignition of the ambulance 10 to turn off, and may subsequently be used to cause the ignition of the ambulance 10 to turn on again before the operator returns to the vehicle (e.g., to let the ambulance warm up before it is needed). This may be performed remotely without the operator having to return to the ambulance. Likewise, the operator may be allowed to use the user interface 14 remotely activate patient care or other equipment from the initial patient treatment site. Further, the status of critical systems may be checked remotely. For example, if it appears that oxygen will be needed, a check of the user interface 14 may be made to confirm that the oxygen supply is at an adequate level. Also, the control system 12 may be configured to activate an audible alert device and/or provide a visual indicator on the user interface 14 at step 108, to provide a remote indication to the operator that an unauthorized individual is attempting to steal the ambulance 10. Additional functions may be incorporated to allow wireless interaction with ambulance 10 and control system 12, for example, for remote diagnosis, system monitoring, and so on, including any/all of those described in App. No. 20030158638.

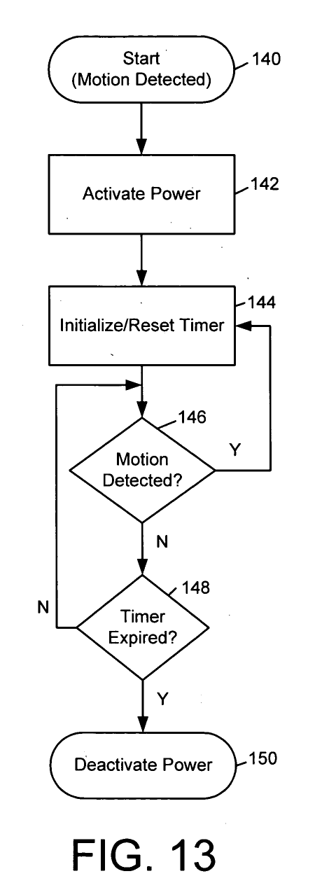

Referring now to FIG. 13, an arrangement is described in which a motion sensor is used to control lighting within a cabin of the ambulance 10. The motion sensor may be connected to one of the interface models 20 of the control system 12. The motion sensor may be mounted on the ceiling of the interior of the cabin (patient compartment) to detect motion in the cabin, such as when a person is entering the vehicle, or when a person is otherwise moving about within the cabin. By way of example, the sensor may be a passive infrared (PIR) sensor which is sensitive to both motion and heat.

At step 140, motion is detected by the sensor. For example, motion may be detected when an operator opens the back door of the ambulance 10. At step 142, power is activated. For example, power to the interface modules 20 may be routed through the sensor, such that the sensor is capable of providing power to each of the interface modules 20 responsive to motion being detected. Once power from the sensor is received, each of the interface modules 20 may power up and begin normal operation. Alternatively, each of the interface modules 20 may be provided with the ability to receive a wakeup signal from the sensor, either directly via a hardwired input (in the case of the interface module 20 to which the sensor is connected) or indirectly (via communication network 50, in the case of the remaining interface modules).

At step 144, a timer is initialized. The timer then begins to count down until it is determined (step 146) that additional motion has been detected. At this point, the process returns to step 144 where the timer is reinitialized. If no motion is detected, the process proceeds to step 148 where it is determined whether time on the timer has expired. If time has expired, then the process proceeds to step 150, where power is deactivated. Thus, once the time delay is activated, the timer will only continue to count down if the motion sensor does not detect motion. Any time motion is detected, the timer resets, thus preventing the vehicle from deactivating while an operator is working in the cabin of the ambulance.

Steps 142-150 may be performed by each interface module 20 in the control system 12. Thus, when motion is detected when the control system 12 is in a “shut-down” state, the interface modules 20 may each power-up and then remain powered up until a predetermined amount of time (as defined by the timer) has elapsed without motion being detected. In an exemplary embodiment, the control system 12 may be configured such that some functions (e.g., interior cabin utility lighting) but not other functions (e.g., cab functions) are available. This arrangement further reduces power drain when an operator is performing routine maintenance tasks in the cabin of the ambulance.

Throughout the specification, numerous advantages of preferred embodiments have been identified. It will be understood of course that it is possible to employ the teachings herein so as to without necessarily achieving the same advantages. Additionally, although many features have been described in the context of an ambulance control system comprising multiple modules connected by a network, it will be appreciated that such features could also be implemented in the context of other hardware configurations. Further, although various figures depict a series of steps which are performed sequentially, the steps shown in such figures generally need not be performed in any particular order. For example, in practice, modular programming techniques are used and therefore some of the steps may be performed essentially simultaneously. Additionally, some steps shown may be performed repetitively with particular ones of the steps being performed more frequently than others. Alternatively, it may be desirable in some situations to perform steps in a different order than shown.

Many other changes and modifications may be made to the present invention without departing from the spirit thereof.

1. An ambulance comprising:
a video camera;
a plurality of input devices and a plurality of output devices;
a plurality of microprocessor-based interface modules and a communication network, the plurality of interface modules being interconnected to each other by way of the communication network, each of the plurality of interface modules being coupled to respective ones of the plurality of input devices and the plurality of output devices to control operation of the plurality of output devices based on input status information from the plurality of inputs devices; and
an user interface including a display, the display being configured to display I/O status information regarding the plurality of input devices and the plurality of output devices, and the display being configured to display video images provided by the video camera.

2. An ambulance according to claim 1, wherein the video camera is a first video camera; wherein the ambulance further comprises a second video camera; and wherein the display is configured to display video images provided by both the first and second video cameras.

3. An ambulance according to claim 2, wherein the first video camera is mounted on the ambulance so as to obtain video information in a first direction away from the ambulance, wherein the second video camera is mounted on the ambulance so as to obtain video information in a second direction away from the ambulance, and wherein the user interface is configured to alter a manner in which the video information from the first and second video cameras is displayed depending on a direction of movement of the ambulance.

4. An ambulance according to claim 2, wherein the user interface is configured to simultaneously display the I/O status information and the video images on the display of the user interface.

5. An ambulance according to claim 1, wherein the user interface is configured to display patient data related to status of a patient.

6. An ambulance according to claim 1, wherein the video camera is a digital video camera.

7. An ambulance according to claim 1, wherein the video camera is configured to provide video images of a patient in a patient compartment of the ambulance.

8. An ambulance according to claim 1, wherein the video camera is configured to provide video images of the ambulance exterior.

9. An ambulance according to claim 1, wherein the display also displays global positioning coordinates from a global positioning receiver.

10. A control system for an ambulance comprising:
a power source;
a power transmission link;
a plurality of input devices;
a plurality of output devices; and
a plurality of microprocessor-based interface modules and a communication network, the plurality of interface modules being coupled to the power source by way of the power transmission link, the plurality of interface modules being interconnected to each other by way of the communication network, each of the plurality of interface modules being coupled to respective ones of the plurality of input devices and the plurality of output devices; and
a user interface, the user interface being coupled to receive patient data related to status of the patient and being configured to display the patient data.

11. A system according to claim 10, wherein the user interface is further configured to display the I/O status information.

12. A system according to claim 10, wherein the patient data is video information comprising images of the patient.

13. A system according to claim 10, wherein the patient data is patient status data indicating a health status level of the patient.

14. A system according to claim 10, further comprising a video camera configured to provide the visual images of the ambulance exterior, and wherein the user interface is coupled to receive and display the visual images of the ambulance exterior.

15. A system according to claim 14, wherein the interface is configured to simultaneously display the I/O status information and the visual images on the display of the user interface.

16. A system according to claim 10, wherein the control system is configured to activate an audible alert device and provide a visual indicator on the user interface when the transmission of ambulance is shifted to the reverse gear.

17. A system according to claim 10, wherein the control system is configured to provide a visual indicator of the current gear of the vehicle transmission on the display of the user interface.

18. A system according to claim 10, wherein the control system is configured to display the sequential activation and deactivation of ambulance subsystems on the user interface as the ambulance battery voltage decreases to predefined power levels.

19. A system according to claim 10, wherein the control system and the user interface are configured to permit an operator to select and program different flash patterns for ambulance lighting.

20. A control system for an ambulance comprising:
a power source;
a power transmission link;
a plurality of input devices;
a plurality of output devices; and
a plurality of microprocessor-based interface modules and a communication network, the plurality of interface modules being coupled to the power source by way of the power transmission link, the plurality of interface modules being interconnected to each other by way of the communication network, each of the plurality of interface modules being coupled to respective ones of the plurality of input devices and the plurality of output devices, the control system being configured to allow engine of the ambulance to remain running without an ignition key being inserted, and the control system being configured to disable the ambulance when an operator input is received without the ignition key being reinserted.

21. A system according to claim 20, wherein the operator input comprises the a transmission of the ambulance being shifted out of park position.

22. A system according to claim 20, wherein the operator input comprises brakes of the ambulance being applied.

23. A system according to claim 20, wherein the control system is configured to control the climate control system of the ambulance, allowing the climate control system to remain running without the ignition key being inserted.

24. A system according to claim 20, wherein the control system is configured to control:
a climate control system of ambulance, allowing the climate control system to remain running without the ignition key being inserted;
an oxygen delivery system, allowing the oxygen delivery system to continue operating without the ignition key being inserted; and
a defibrillator system, allowing the defibrillator system to continue receiving power to maintain operation without the ignition key being inserted.

25. A method for disabling the operation of an ambulance through the use of a control system with a plurality of input devices, a plurality of output devices, a plurality of microprocessor-based interface modules interconnected by a communication network, the plurality of interface modules being coupled to respective ones of the plurality of input devices and the plurality of output devices, the method comprising the steps of:
receiving I/O status information by an interface module from an input device in relation to status of engine operation;
processing I/O status information by an interface module;
identifying a depression of the brake pedal or a change in transmission gear from the park position by transmission electronic control system;
identifying lack of a vehicle ignition key in vehicle ignition by an input device and an interface module;
transmitting status of the input device by the interface module; and
disabling the engine of the ambulance by the control system responsive to the lack of the ignition key and responsive to an operator input.

26. A method according to claim 25, wherein the operator input comprises depression of a brake pedal.

27. A method according to claim 25, wherein the operator input comprises a transmission being moved out of a park position.

28. A method according to claim 25, wherein the engine disabling operation is reset when the vehicle operator inserts the ignition key into the ignition and the ambulance is operable.

29. A control system for an ambulance comprising:
a power source;
a power transmission link;
user interface;
a plurality of input devices;
a plurality of output devices; and
a plurality of microprocessor-based interface modules and a communication network, the plurality of interface modules being coupled to the power source by way of the power transmission link, the plurality of interface modules being interconnected to each other by way of the communication network, each of the plurality of interface modules being coupled to respective ones of the plurality of input devices and the plurality of output devices;
wherein the control system is configured to provide I/O status information related to the plurality of input and output devices of the ambulance.

30. A control system for a vehicle comprising:
a video camera;
a plurality of input devices and a plurality of output devices;
a plurality of microprocessor-based interface modules and a communication network, the plurality of interface modules being interconnected to each other by way of the communication network, each of the plurality of interface modules being coupled to respective ones of the plurality of input devices and the plurality of output devices to control operation of the plurality of output devices based on input status information from the plurality of inputs devices; and
an user interface including a display, the display being configured to display I/O status information regarding the plurality of input devices and the plurality of output devices, and the display being configured to display video images provided by the video camera.

31. An ambulance comprising:
a motion sensor;
a plurality of input devices and a plurality of output devices, the plurality of output devices including a plurality of devices that provide lighting in a cabin of the ambulance;
a plurality of microprocessor-based interface modules and a communication network, the plurality of interface modules being interconnected to each other by way of the communication network, each of the plurality of interface modules being coupled to respective ones of the plurality of input devices and the plurality of output devices to control operation of the plurality of output devices based on input status information from the plurality of inputs devices; and
wherein the motion sensor in combination with the plurality of microprocessor-based interface modules are configured and programmed to detect motion within the cabin of the ambulance and to activate and maintain the lighting within the cabin of the ambulance for at least a minimum period of time after the motion in the cabin of the ambulance is initially detected.

32. A vehicle comprising:
a dispatch system;
a global positioning system;
a plurality of input devices and a plurality of output devices;
a plurality of microprocessor-based interface modules and a communication network, the plurality of interface modules being interconnected to each other by way of the communication network, each of the plurality of interface modules being coupled to respective ones of the plurality of input devices and the plurality of output devices to control operation of the plurality of output devices based on input status information from the plurality of inputs devices; and
an user interface including a display, the user interface being configured to display I/O status information regarding the plurality of input devices and the plurality of output devices, and the user interface being configured to display a map generated based on a present location of a vehicle and a desired location of the vehicle, the present location of the vehicle being provided by the global positioning system, and the desired location of the vehicle being provided by the dispatch system.

33. A vehicle according to claim 32, wherein the user interface is further configured to display a plurality of buttons corresponding to selected ones of the plurality of output devices, wherein the display comprises a touch screen display, wherein the user interface is configured to detect a touch press of a user on one of the displayed buttons, and wherein the interface modules are configured to alter operating states of the plurality of output devices based on the detection of the touch press of corresponding ones of the plurality of buttons.

34. A vehicle according to claim 32, wherein the display is a touchscreen display.

35. A vehicle according to claim 32, further comprising a video camera, and wherein the user interface is further configured to display video images provided by the video camera.

36. A vehicle according to claim 35, wherein display is a color display having at least 800×600 pixel resolution.

37. A vehicle according to claim 35, wherein display is a color display having at least 1024×768 pixel resolution.

38. A vehicle according to claim 35, wherein the user interface is configured to simultaneously display the I/O status information and the video images on the display of the user interface.
